(19) United States
(12) Patent Application Publication
(10) Pub. No.: US 2026/0036182 A1
(43) Pub. Date: Feb. 5, 2026

(54) PISTON ASSEMBLY, MAGNETORHEOLOGICAL DAMPER, AND VEHICLE

(71) Applicant: T-MAX (HANGZHOU) TECHNOLOGY CO., LTD., Hangzhou (CN)

(72) Inventors: Xinfa DU, Hangzhou (CN); Yongyong ZHAN, Hangzhou (CN); Ke WANG, Hangzhou (CN); Songfeng WANG, Hangzhou (CN); Lei YANG, Hangzhou (CN)

(21) Appl. No.: 19/286,765

(22) Filed: Jul. 31, 2025

(30) Foreign Application Priority Data
Jul. 31, 2024 (CN) 202411045409.5

(51) Int. Cl. F16F 9/32; B60G 13/00; B60G 15/12; F16F 9/53

(52) U.S. Cl. CPC F16F 9/3214; B60G 13/003; B60G 15/12; F16F 9/535; B60G 2202/24; B60G 2206/41; F16F 2224/045; F16F 2230/30

(57) ABSTRACT

Disclosed are a piston assembly, a magnetorheological damper, and a vehicle. The piston assembly includes a piston casing, a coil component and an iron core component, where a mounting chamber is arranged inside the piston casing, and the iron core component includes a primary and a secondary iron core. A central main flow channel is arranged inside the primary iron core and axially runs through the primary iron core, and a central auxiliary flow channel is arranged inside the secondary iron core and axially runs through the secondary iron core. An outer peripheral wall of the secondary iron core and an inner peripheral wall of the piston casing define an edge axial flow channel, and ends of the secondary iron core and the piston casing define an auxiliary radial flow channel and a main radial flow channel, respectively. At least some of the channels are in communication with each other.

### CROSS-REFERENCE TO RELATED APPLICATION

This patent document claims priority to and benefits of Chinese Patent Application Serial No. 202411045409.5, filed on Jul. 31, 2024. The entire content of the aforementioned patent application is incorporated by reference for all purposes.

### TECHNICAL FIELD

This patent document relates the field of damper technology, particularly to a piston assembly, a magnetorheological damper, and a vehicle.

### BACKGROUND

Magnetorheological damper is different from traditional hydraulic damper. The cylinder of the magnetorheological damper is filled with magnetorheological fluid, and the piston assembly of the magnetorheological damper is equipped with a coil. The magnitude of the current on the coil can be controlled to adjust a damping force of the magnetorheological damper in real time according to a vibration reduction target. Due to excellent controllable performances of the magnetorheological damper, such as continuous adjustable damping, high precision and fast response speed, the magnetorheological damper is widely used instead of the traditional hydraulic damper. Typical applications include robot devices, automobile clutches, suspension systems, and vibration control of large civil structures.

### SUMMARY

Disclosed are devices, systems, and methods for a piston assembly, a magnetorheological damper, and a vehicle.

Some example embodiments in accordance with the present technology provide a piston assembly. The piston assembly includes: a piston casing having a first end and a second end along an axial direction of the piston casing, wherein a mounting chamber is arranged inside the piston casing, the first end of the piston casing is provided with a fluid inlet, and the second end of the piston casing is provided with a fluid outlet; a coil component arranged coaxially in the mounting chamber; and an iron core component, comprising: a primary iron core arranged inside the mounting chamber and sleeved inside the coil component, wherein a central main flow channel is arranged inside the primary iron core axially runs through the primary iron core; and a secondary iron core arranged inside the mounting chamber and arranged at an end of the primary iron core along an axial direction of the mounting chamber, wherein a central auxiliary flow channel is arranged inside the secondary iron core and axially runs through the secondary iron core, and an outer peripheral wall of the secondary iron core and an inner peripheral wall of the piston casing define an edge axial flow channel, and wherein the secondary iron core has a first end and a second end, the first end of the secondary iron core and the piston casing define an auxiliary radial flow channel, and the second end of the secondary iron core and the primary iron core define a main radial flow channel; in which the edge axial flow channel and the central auxiliary flow channel are both in communication with the auxiliary radial flow channel and the main radial flow channel, the main radial flow channel is in communication with the central main flow channel, and the edge axial flow channel is in communication with the fluid inlet and the fluid outlet.

Some example embodiments in accordance with the present technology provide a magnetorheological damper. The magnetorheological damper includes: the piston assembly according to any one of the embodiments of the disclosed technology, in which the piston assembly further includes a piston rod coupled with the piston casing; and a cylinder barrel, a vehicle frame connector, and a suspension connector, in which the vehicle frame connector is arranged at one end of the cylinder barrel, and the cylinder barrel is filled with magnetorheological fluid, in which the piston assembly is slidably fitted in the cylinder barrel, and one end of the piston rod extends out of another end of the cylinder barrel and is coupled with the suspension connector.

Some example embodiments in accordance with the present technology provide a vehicle. The vehicle includes: the magnetorheological damper according to any one of the embodiments of the disclosed technology.

The subject matter described in this patent document can be implemented in specific ways that provide one or more of the following features.

### BRIEF DESCRIPTION OF THE DRAWINGS

FIG. 1 shows a diagram depicting an axial view of a piston assembly according to an example embodiment of the disclosed technology.

FIG. 2 shows a diagram depicting a top view of a piston assembly (without a piston rod) according to an example embodiment of the disclosed technology.

FIG. 3 shows a diagram depicting a cross-sectional view of a piston assembly according to an example embodiment of the disclosed technology along a sectioning line of A-A in FIG. 2.

FIG. 4 shows a diagram depicting a cross-sectional view of a piston assembly (under a low current condition) according to an example embodiment of the disclosed technology along a sectioning line of B-B in FIG. 2.

FIG. 5 shows a diagram depicting a cross-sectional view of a piston assembly (under a high current condition) according to an example embodiment of the disclosed technology along a sectioning line of B-B in FIG. 2.

FIG. 6 shows a diagram depicting a magnetic field distribution diagram of a piston assembly according to an example embodiment of the disclosed technology.

FIG. 7 shows a diagram depicting an explosion diagram of a piston assembly according to an example embodiment of the disclosed technology.

FIG. 8 shows a diagram depicting a schematic diagram of a coil component of a piston assembly according to an example embodiment of the disclosed technology.

FIG. 9 shows a diagram depicting a mounting diagram of a coil component, an auxiliary iron core and an auxiliary bracket of a piston assembly according to an example embodiment of the disclosed technology.

FIG. 10 shows a diagram depicting a schematic diagram of a piston assembly (without a piston upper cover, a piston lower cover and a piston rod) according to an example embodiment of the disclosed technology.

FIG. 11 shows a diagram depicting a schematic diagram of a piston assembly (without a piston rod) according to an example embodiment of the disclosed technology.

FIG. 12 shows a diagram depicting an axial view of a magnetorheological damper according to an example embodiment of the disclosed technology.

FIG. 13 shows a diagram depicting a partial cross-sectional view of a magnetorheological damper according to an example embodiment of the disclosed technology.

FIG. 14 shows a diagram depicting another partial cross-sectional view of a magnetorheological damper according to an example embodiment of the disclosed technology.

FIG. 15 shows a diagram depicting an application scenario diagram of a magnetorheological damper according to an example embodiment of the disclosed technology.

### DETAILED DESCRIPTION

Embodiments of the disclosed technology are described in detail below, and examples of the embodiments are shown in the accompanying drawings. The embodiments described below with reference to the accompanying drawings are exemplary, i.e., examples, and intended to explain the disclosed technology and should not be constructed as limiting the disclosed technology.

Conventionally, in order to achieve a large damping force of the magnetorheological damper, a plurality of axially arranged coils are usually arranged on the piston. However, the conventional approach results in a large axial size of the piston, which leads to insufficient installation space of the magnetorheological damper, reduced strength of the piston rod, and increased volume of the damper chamber.

Disclosed are devices, systems, and methods for a piston assembly, a magnetorheological damper, and a vehicle that are technically advantaged over conventional approaches.

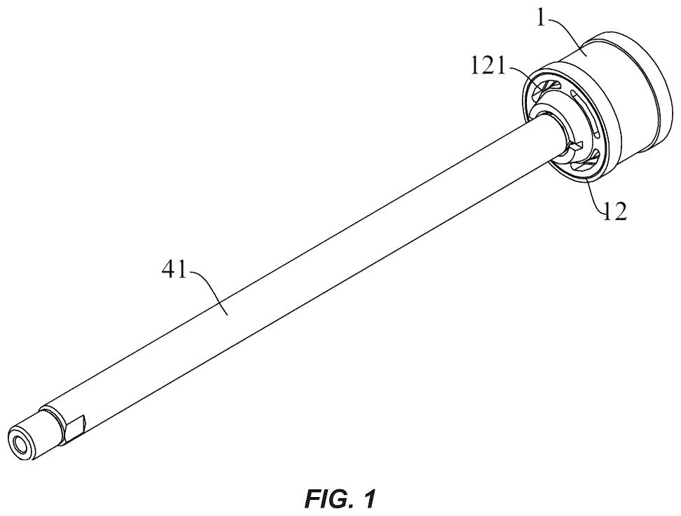

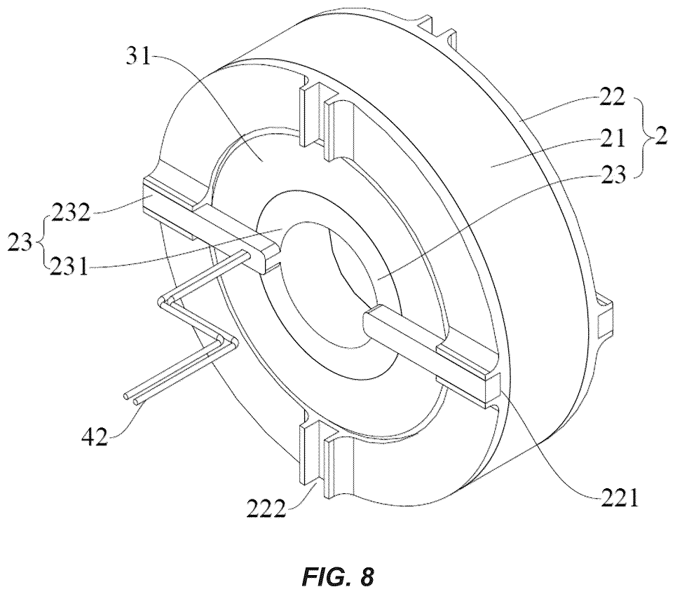

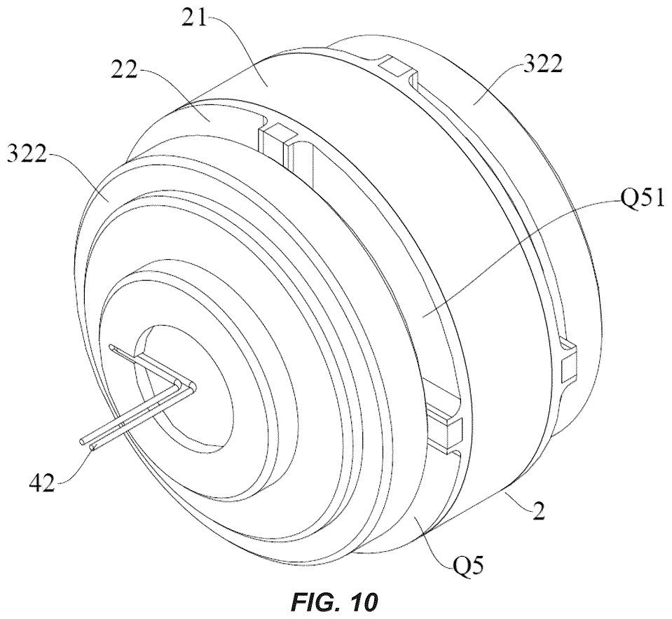

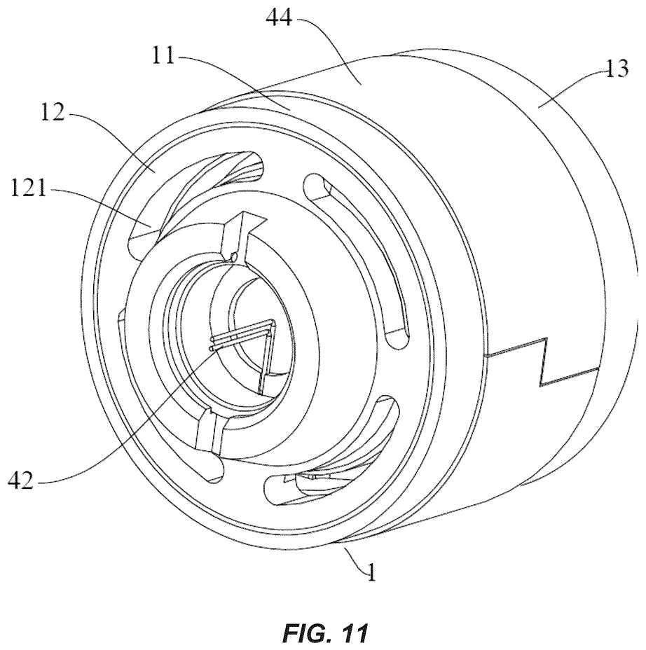

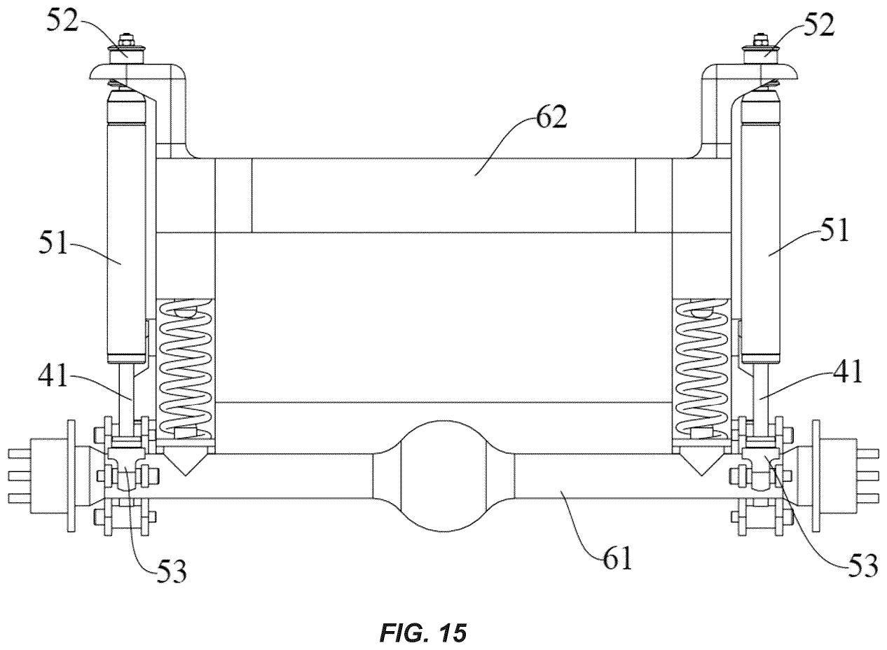

Example embodiments of a piston component, a magnetorheological damper, and a vehicle, in accordance with the present technology, are described below with reference to FIG. 1 to FIG. 15.

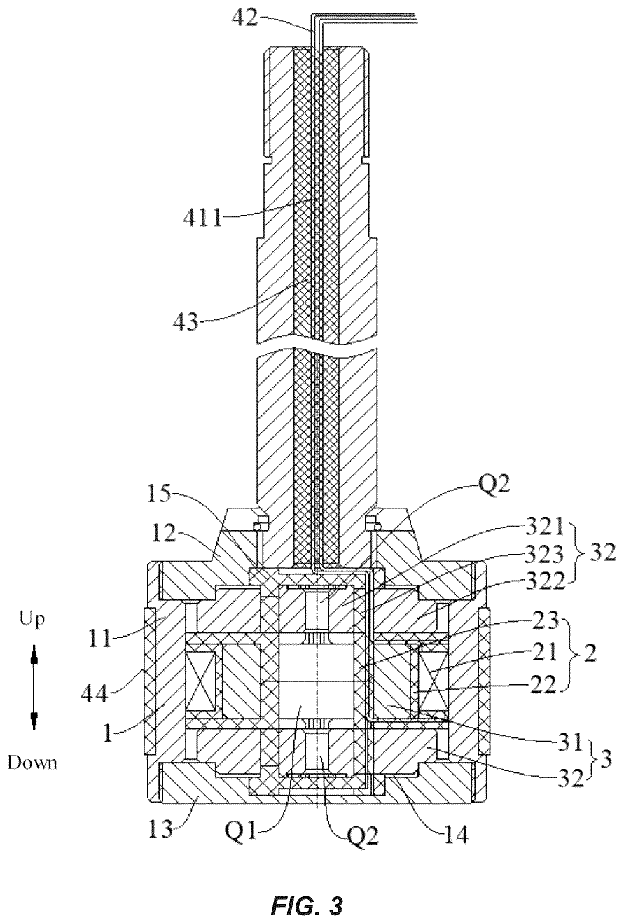

As shown in FIG. 1 to FIG. 6, an example embodiment of the piston component includes: a piston casing 1, a coil component 2 and an iron core component 3. A mounting chamber 14 is arranged inside the piston casing 1, and two ends of the piston casing 1 along an axial direction (e.g., an upper and lower direction in FIG. 3) of the piston casing 1 are provided with a fluid inlet 121 and a fluid outlet 122 respectively. The coil component 2 is arranged coaxially in the mounting chamber 14. The iron core component 3 includes a primary iron core 31 and a secondary iron core 32. The coil component 2 can generate a magnetic field after being energized to magnetize the primary iron core 31 and the secondary iron core 32.

The primary iron core 31 and the secondary iron core 32 are both arranged inside the mounting chamber 14. The primary iron core 31 is sleeved inside the coil component 2, and the secondary iron core 32 is arranged at an end of the primary iron core 31 along an axial direction of the mounting chamber 14. A central main flow channel Q1 is arranged inside the primary iron core 31 and axially runs through the primary iron core 31, and a central auxiliary flow channel Q2 is arranged inside the secondary iron core 32 and axially runs through the secondary iron core 32. An edge axial flow channel Q3 is defined between an outer peripheral wall of the secondary iron core 32 and an inner peripheral wall of the piston casing 1, an auxiliary radial flow channel Q4 is defined between an end of the secondary iron core 32 (e.g., an upper end surface of the secondary iron core 32 in FIG. 3) and the piston casing 1, and a main radial flow channel Q5 is defined between another end of the secondary iron core 32 (e.g., a lower end surface of the secondary iron core 32 in FIG. 3) and the primary iron core 31. The edge axial flow channel Q3 and the central auxiliary flow channel Q2 are both in communication with the auxiliary radial flow channel Q4 and the main radial flow channel Q5, the main radial flow channel Q5 is in communication with the central main flow channel Q1, and the edge axial flow channel Q3 is in communication with the fluid inlet 121 and the fluid outlet 122.

As shown in FIG. 3, the central main flow channel Q1, the edge axial flow channel Q3 and the central auxiliary flow channel Q2 all extend along the axial direction (e.g., the upper and lower direction in FIG. 3) of the mounting chamber 14. The auxiliary radial flow channel Q4 and the main radial flow channel Q5 extend along a horizontal direction (i.e., a direction perpendicular to the axial direction of the mounting chamber 14).

According to the piston assembly of example embodiments of the disclosed technology, the central auxiliary flow channel Q2 is arranged inside the secondary iron core 32, the edge axial flow channel Q3 is defined between the outer peripheral wall of the secondary iron core 32 and the inner peripheral wall of the piston casing 1, the auxiliary radial flow channel Q4 is defined between an end of the secondary iron core 32 and the piston casing 1, and the main radial flow channel Q5 is defined between another end of the secondary iron core 32 and the primary iron core 31. Therefore, during the operation of the piston assembly, the magnetorheological fluid enters the mounting chamber 14 from the fluid inlet 121 and then flows along the axial direction of the mounting chamber 14 in the edge axial flow channel Q3. As both the edge axial flow channel Q3 and the central auxiliary flow channel Q2 are in communication with the auxiliary radial flow channel Q4 and the main radial flow channel Q5, a portion of the magnetorheological fluid will enter the auxiliary radial flow channel Q4 and the central auxiliary flow channel Q2, and then merge into the central main flow channel Q1. Another portion of the magnetorheological fluid can enter the main radial flow channel Q5 and then merge into the central main flow channel Q1. By increasing a flow path of magnetorheological fluid in the mounting chamber 14, a damping force of the piston assembly during operation can be increased, which is beneficial for reducing an axial size of the magnetorheological damper, thus improving the problems of insufficient installation space, reduced strength of a piston rod 41, and increased volume of the damper chamber.

On the other hand, since both the primary iron core 31 and the secondary iron core 32 can be magnetized by the magnetic field of the coil component 2, and the main core 31 and the secondary iron core 32 jointly construct the edge axial flow channel Q3, the auxiliary radial flow channel Q4, the main radial flow channel Q5, the central auxiliary flow channel Q2, and the central main flow channel Q1, a viscosity of the magnetorheological fluid thus increases rapidly after passing through the above flow channels to ensure that the magnetorheological damper can output a sufficiently large damping force.

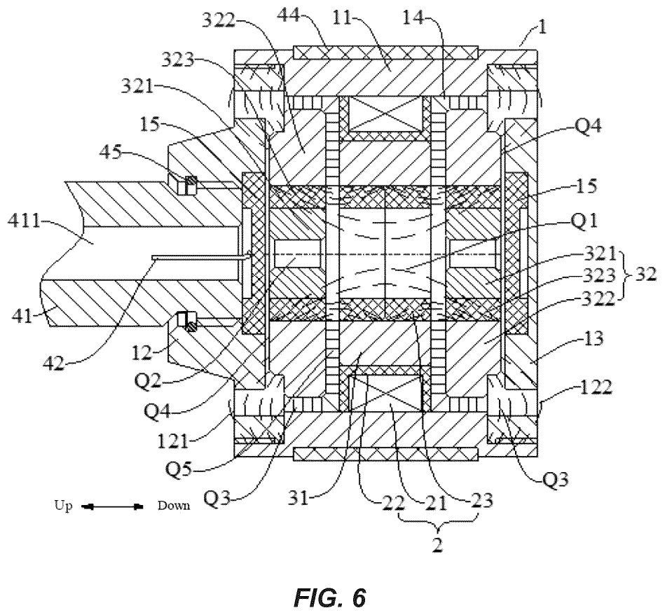

As shown in FIG. 6, the magnetorheological fluid can produce a coagulation effect under the action of the magnetic field, which increases the viscosity of the fluid and a resistance through the flow channels, thereby producing a damping effect. By adjusting the current, a magnetic field strength of an electromagnetic coil 21 can be changed, and thus the viscosity of the magnetorheological fluid passing through the flow channel can be adjusted to achieve an adjustment of the damping force.

It can be understood that the piston assembly of example embodiments in accordance with the disclosed technology adopts two aspects, i.e., the radial flow channel and the axial toroidal flow channel, to increase the effective damping channel of the piston assembly. Therefore, the solution of the disclosed technology can expand the damping force requirement of the piston assembly without increasing the axial length of the coil, without increasing the structural volume and power consumption of the piston, and without reducing the strength of the piston rod 41.

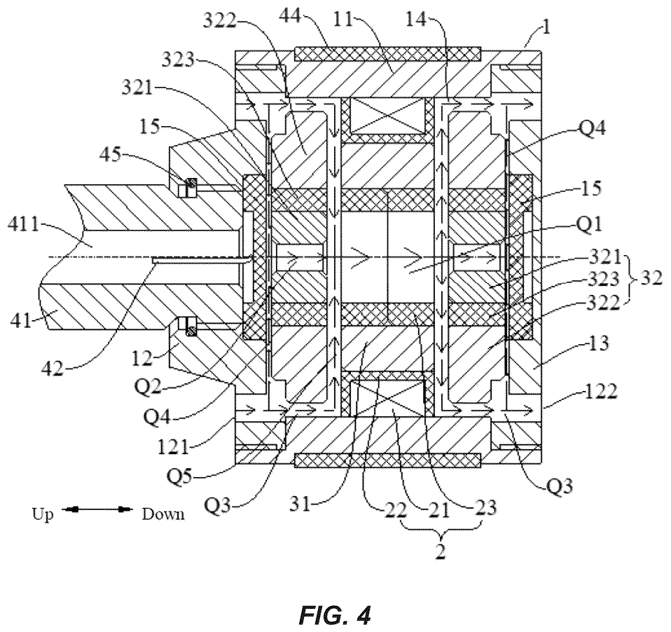

Optionally, an axial (e.g., an upper and lower direction in FIG. 4) interval of the auxiliary radial flow channel Q4 is smaller than an axial (e.g., the upper and lower direction in FIG. 4) interval of the main radial flow channel Q5.

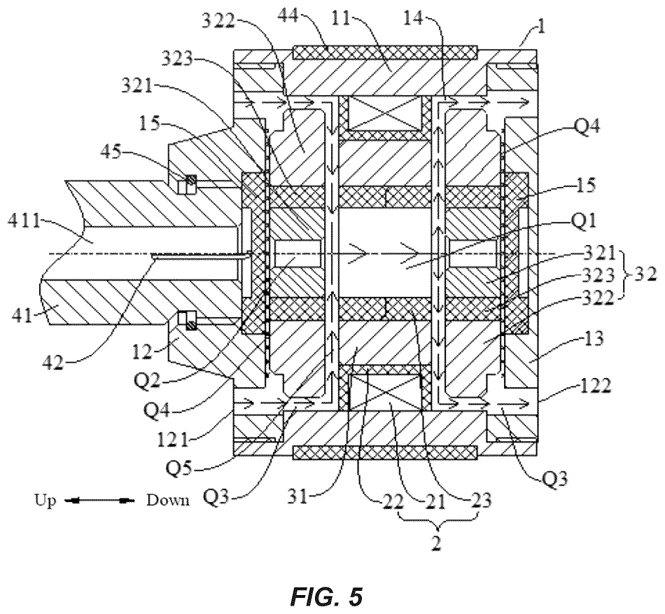

It can be understood that the axial interval of the auxiliary radial flow channel Q4 is smaller. As shown in FIG. 5, when the current exceeds a certain threshold (such as 1A-2A), the magnetorheological fluid flowing in the auxiliary radial flow channel Q4 is affected by the magnetic field, resulting in a decrease in fluidity. In this case, the majority of the magnetorheological fluid can flow into the central main flow channel Q1 through the main radial flow channel Q5, thereby reducing the overall flow of the piston assembly to obtain a damping adjustment range with a higher upper limit under high current conditions.

Similarly, as shown in FIG. 4, when the current is less than a certain threshold (such as 0-1A), the magnetorheological fluid flowing in the auxiliary radial flow channel Q4 can maintain a good passability. In this case, most of the magnetorheological fluid can flow into the central main flow channel Q1 through the main radial flow channel Q5, and a small portion of the magnetorheological fluid can flow into the central main flow channel Q1 through the auxiliary radial flow channel Q4, which thus can increase the overall flow of the piston assembly to obtain a damping adjustment range with a lower lower limit under low current conditions.

Therefore, the piston assembly of example embodiments of the disclosed technology can change the working flow channel mode of the piston assembly under different adjustment currents by setting the auxiliary radial flow channel Q4, thereby having different adjustment gradients, so that the magnetorheological damper can have two working modes of high damping section and low damping section.

That is, the magnetorheological damper has a combined adjustment method of current regulation and channel regulation, ensuring lower damping force in a low current section and a higher damping force in a high current section.

Optionally, the axial interval of the auxiliary radial flow channel Q4 is L1, and the axial interval of the main radial flow channel Q5 is L2, where 0.8 mm≤L1≤1.2 mm, and 2.8 mm≤L2≤3.2 mm. For example, the value of L1 can be 0.8 mm, 0.9 mm, 1.0 mm, 1.1 mm, or 1.2 mm. The value of L2 can be 2.8 mm, 2.9 mm, 3.0 mm, 3.1 mm, or 3.2 mm.

Example implementations of the disclosed technology conducing experimental research found that if L1 and L2 adopt the above parameter range, on the one hand, when the coil component 2 is in the current regulation section of 0-1A, it can ensure that the auxiliary radial flow channel Q4 and the main radial flow channel Q5 can both flow magnetorheological fluid, thereby increasing the overall flow of the piston assembly to obtain a damping adjustment range with a lower lower limit under low current conditions. On the other hand, when the coil component 2 is in the current regulation section of 1A-2A, it can ensure that the magnetorheological fluid in the auxiliary radial flow channel Q4 is blocked, but the magnetorheological fluid can flow normally in the main radial flow channel Q5, thereby reducing the overall flow of the piston component to obtain a damping adjustment range with a higher upper limit under high current conditions.

In some embodiments, as shown in FIG. 3 to FIG. 6, there are two secondary iron core 32, the two secondary iron cores 32 are arranged at two sides of the primary iron core 31 respectively, and each secondary iron core 32 defines the edge axial flow channel Q3, the auxiliary radial flow channel Q4, and the main radial flow channel Q5 with the piston casing 1 and the primary iron core 31. It is understandable that the two secondary iron cores 32 are symmetrically arranged on the upper and lower sides of the primary iron core 31, which can thus further increase the damping force of the piston assembly during operation.

Specifically, as shown in FIG. 3 to FIG. 6, the piston casing 1 includes a piston upper cover 12, a sleeve iron core 11 and a piston lower cover 13, and the piston upper cover 12 and the piston lower cover 13 are respectively arranged at both ends of the sleeve iron core 11. The piston upper cover 12 and the piston lower cover 13 define the mounting chamber 14 with the sleeve iron core 11. The piston upper cover 12 is provided with the fluid inlet 121, and the piston lower cover 13 is provided with the fluid outlet 122. One of the secondary iron core 32, the piston upper cover 12, and the sleeve iron core 11 define a set of the edge axial flow channel Q3, the auxiliary radial flow channel Q4 and the main radial flow channel Q5 which are in communication with the fluid inlet 121. Another secondary iron core 32, the piston lower cover 13 and the sleeve iron core 11 define another set of the edge axial flow channel Q3, the auxiliary radial flow channel Q4 and the main radial flow channel Q5 which are in communication with the fluid outlet 122. In other words, there are two edge axial flow channel Q3, two auxiliary radial flow channel Q4 and two main radial flow channel Q5, which are arranged on the upper and lower sides of the primary iron core 31, which can further expand the damping adjustment range of the magnetorheological damper.

It can be understood that, as shown in FIG. 4, if the piston assembly is in the low current section (0-1A) control, a flow path of the magnetorheological fluid in the piston assembly is: the fluid inlet 121→the edge axial flow channel Q3→ “the auxiliary radial flow channel Q4+the main radial flow channel Q5”→the central main flow channel Q1→ “the auxiliary radial flow channel Q4+the main radial flow channel Q5”→the edge axial flow channel Q3→the fluid outlet 122.

As shown in FIG. 5, if the piston assembly is in the high current section (1A-2A) control, a flow path of the magnetorheological fluid in the piston assembly is: the fluid inlet 121→the edge axial flow channel Q3→the main radial flow channel Q5→the central main flow channel Q1→the main radial flow channel Q5→ the edge axial flow channel Q3→the fluid outlet 122.

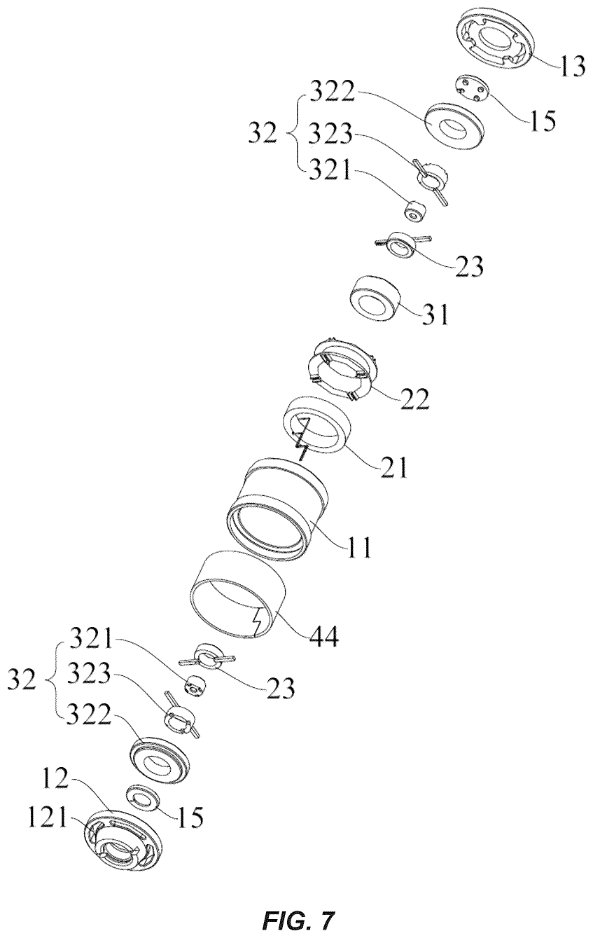

In some embodiments, as shown in FIG. 7 to FIG. 9, the coil component 2 includes a coil frame 22, an electromagnetic coil 21, and a main bracket 23. The electromagnetic coil 21 is wound on the coil frame 22, that is, the copper wire of the electromagnetic coil 21 is wound around the coil frame 22, and the coil frame 22 can serve to fix the electromagnetic coil 21. The primary iron core 31 is mounted inside the coil frame 22. The main bracket 23 includes a main bracket body 231 and a first support arm 232, in which the main bracket body 231 is sleeved inside the primary iron core 31, and the first support arm 232 is arranged on one side of the main bracket body 231 along the axial direction of the mounting chamber 13. A first slot 221 is arranged on one side of the coil frame 22 close to the secondary iron core 32, and the first support arm 232 is mounted in the first slot 221, and in contact with the secondary iron core 32.

It can be understood that, as shown in FIG. 7 to FIG. 9, the first support arm 232 is mounted in the first slot 221 to clamp and fix the main bracket 23 with the coil frame 22. Due to the first support arm 232 being in contact with the secondary iron core 32, a certain distance can be generated between the secondary iron core 32 and the coil frame 22, which can form the main radial flow channel Q5. For example, there can be two or more of the first support arm 232. Several first support arms 232 are arranged at intervals along a circumference of the main bracket 23 and extend radially. The main radial flow channel Q5 is divided into a plurality of fan-shaped main radial sub-flow channels Q51 by several first support arms 232, which can make the distribution of the magnetorheological fluid flowing through the main radial flow channel Q5 more uniform, and is beneficial to increase the contact area between the magnetorheological fluid and the primary iron core 31 and the secondary iron core 32, thereby improving the damping force.

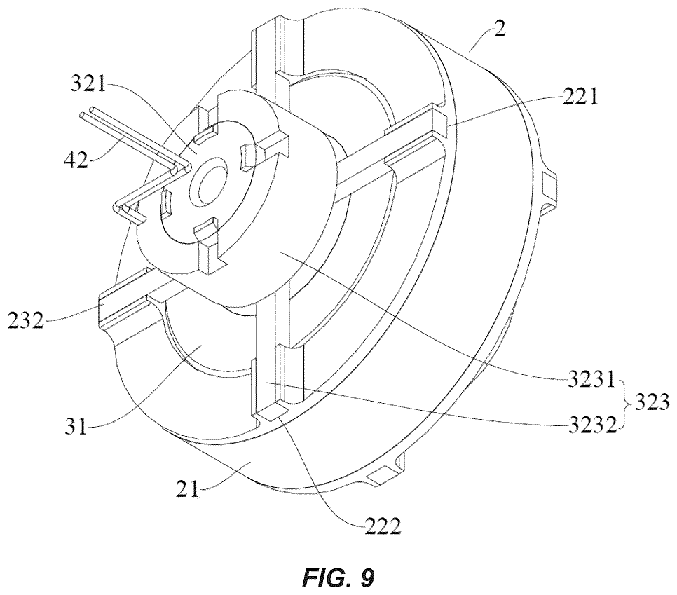

Furthermore, as shown in FIG. 3 to FIG. 7, and FIG. 9, the secondary iron core 32 includes an auxiliary iron core 321, an auxiliary bracket 323 and an end iron core 322. The auxiliary bracket 323 includes an auxiliary bracket body 3231 and a second support arm 3232, and the second support arm 3232 is arranged on one side of the auxiliary bracket body 3231 close to the coil frame 22. A second slot 222 is arranged on one side of the coil frame 22 close to the secondary iron core 32, and the second support arm 3232 is mounted in the second slot 222. The auxiliary bracket body 3231 is sleeved inside the end iron core 322, and the auxiliary iron core 321 is sleeved inside the auxiliary bracket body 3231. Therefore, this makes it easy to fix the auxiliary iron core 321 and the end iron core 322, with a simple structural design and easy installation.

The edge axial flow channel Q3 is defined between an outer peripheral wall of the end iron core 322 and an inner peripheral wall of the piston casing 1 (the piston upper cover 12 and/or the piston lower cover 13), and the central auxiliary flow channel Q2 is arranged inside the auxiliary iron core 321 and axially runs through the auxiliary iron core 321. It is understandable that the auxiliary bracket 323 is configured to fix the auxiliary iron core 321 and the end iron core 322, and the auxiliary bracket body 3231 is supported between the auxiliary iron core 321 and the end iron core 322. For the secondary iron core 32 close to the piston upper cover 12, upper end surfaces of the auxiliary bracket body 3231, the auxiliary iron core 321 and the end iron core 322 define jointly the auxiliary radial flow channel Q4 with the piston upper cover 12. Lower end surfaces of the auxiliary bracket body 3231, the auxiliary iron core 321 and the end iron core 322 jointly define the main radial flow channel Q5 with an upper end surface of the coil component 2.

Optionally, there are a plurality of first support arms 232 and a plurality of second support arms 3232, and the plurality of first support arms 232 and the plurality of second support arms 3232 are arranged at intervals along a circumference of the auxiliary bracket body 3231 to divide the main radial flow channel Q5 into a plurality of main radial sub-flow channels Q51.

For example, as shown in FIG. 9, there are two first support arm 232 which are symmetrically arranged along the radial direction, and there are two second support arm 3232 which are symmetrically arranged along the radial direction. The arrangement of the two first support arms 232 and the two second support arms 3232 is generally in the shape of “cross.” Therefore, the main radial flow channel Q5 can be divided into four fan-shaped main radial sub-flow channels Q51, which can make the distribution of the magnetorheological fluid flowing through the main radial flow channel Q5 more uniform, and is conducive to increasing the contact area between the magnetorheological fluid and the primary iron core 31 and the auxiliary iron core 32, and improving the damping force.

Correspondingly, there can be a plurality of the fluid inlets 121 and a plurality of the fluid outlets 122. The plurality of fluid inlets 121 are arranged at intervals along a circumference of the piston upper cover 12, and the plurality of fluid outlets 122 are arranged at intervals along a circumference of the piston lower cover 13. For example, the plurality of fluid inlets 121 or the plurality of fluid outlets 122 can correspond one-to-one with a plurality of main radial sub-flow channels Q51.

In some embodiments, as shown in FIG. 3 to FIG. 7, the piston assembly further includes a piston rod 41 and a wire 42. The piston rod 41 is coupled with the piston casing 1, and the piston rod 41 is provided with a wire channel 411 that axially runs through the piston rod 41. The wire channel 411 is in communication with the mounting chamber 14, and the wire 42 is threaded through the wire channel 411 and electrically connected with the coil component 2. Understandably, the wire 42 can be hidden in the wire channel 411 of the piston rod 41 to avoid damage of the wire 42 when the piston assembly moves, which is beneficial to prolong a service life of the magnetorheological damper and has a good reliability.

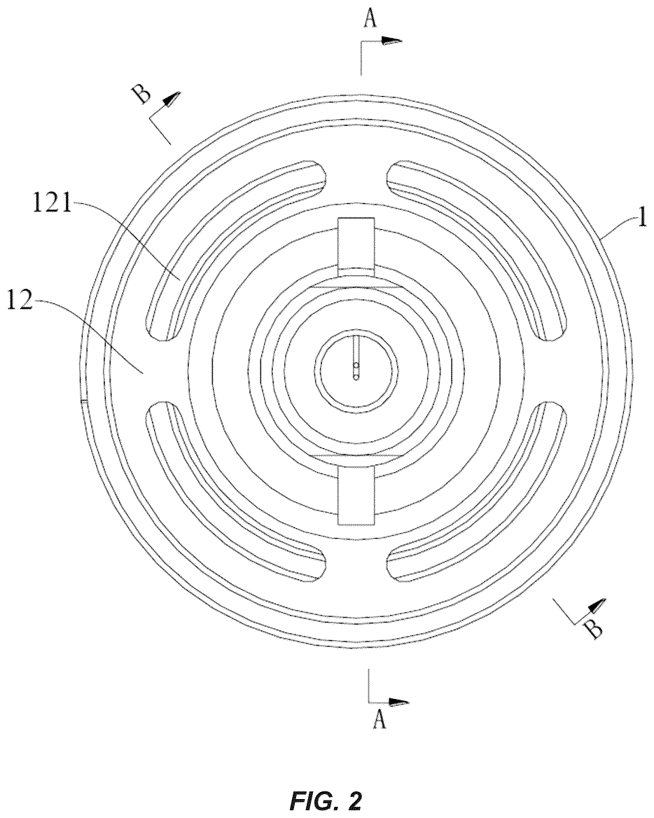

As shown in FIG. 2, the piston assembly of example embodiments of the disclosed technology can improve the structural strength of the piston rod 41 and avoid the problem of fracture when the piston rod 41 is subjected to a large load by setting the fluid inlet 121 on the piston casing 1 instead of on the piston rod 41.

Optionally, as shown in FIG. 3, the piston assembly further includes a sealing filler 43, which is arranged inside the wiring channel 411 and wraps around the wire 42 to fix and scal the wire 42. The piston assembly further includes a wear-resistant strip 44, which is sleeved on an outer peripheral wall of the piston casing 1. The wear resistant strip 44 can provide guidance for the movement of the piston casing 1 and improve a wear resistance performance and a sealing performance of the piston assembly.

Specifically, as shown in FIG. 3 to FIG. 7, the piston assembly further includes two auxiliary flow channel end covers 15, and the two auxiliary flow channel end covers 15 are arranged in the mounting chamber 14. One auxiliary flow channel end cover 15 is mounted on the piston upper cover 12 and in contact with one auxiliary bracket 323, and another auxiliary flow channel end cover 15 is mounted on the piston lower cover 13 and in contact with another auxiliary bracket 323.

As shown in FIG. 3 to FIG. 6, the connection position of the piston rod 41 and the piston upper cover 12 is provided with a steel wire retaining ring 45, which is configured to fix the piston rod 41 and the piston upper cover 12.

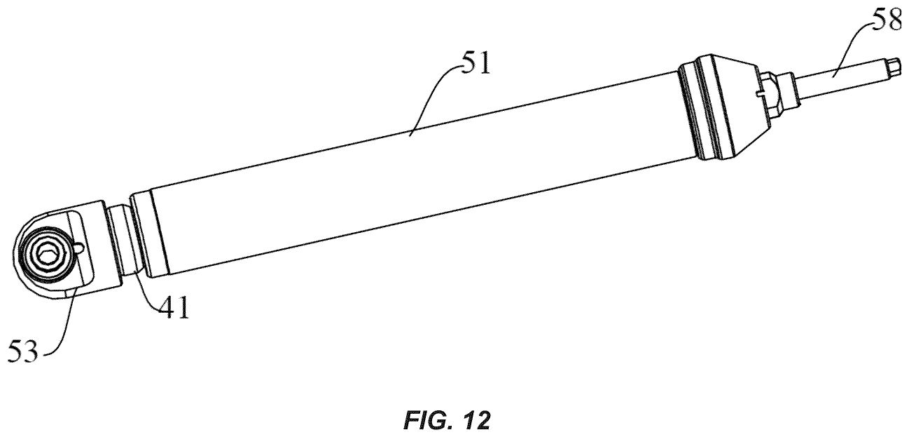

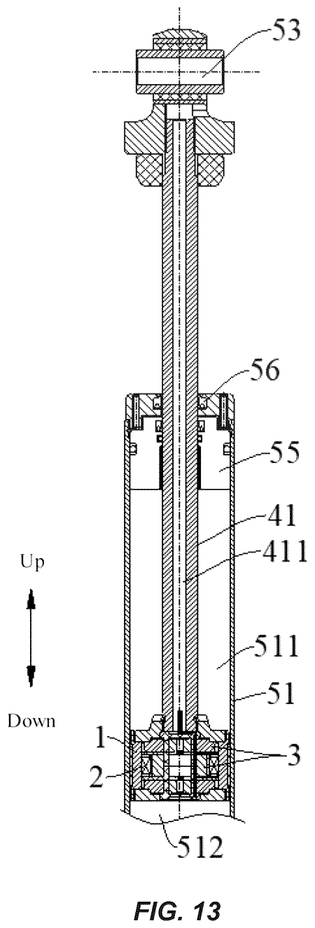

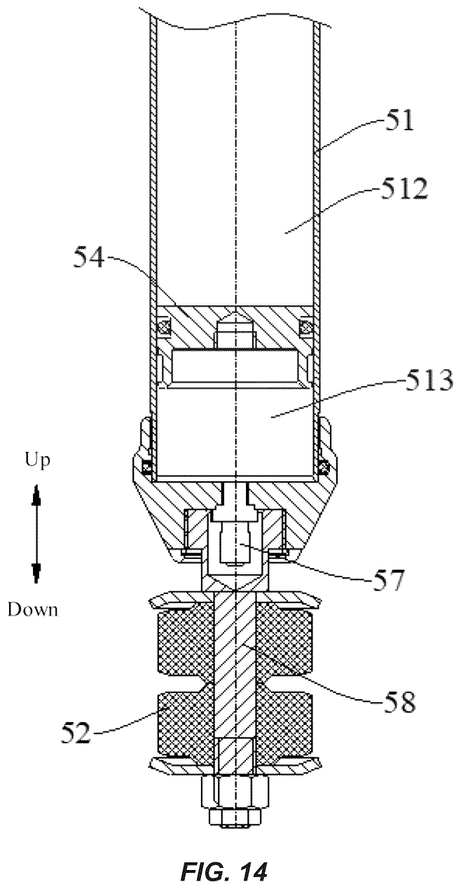

As shown in FIG. 12 to FIG. 15, the magnetorheological damper according to another embodiment of the invention includes a piston assembly, a cylinder barrel 51, a vehicle frame connector 52, and a suspension connector 53. The piston assembly is the piston assembly according to example embodiments of the disclosed technology. The piston assembly further includes the piston rod 41, the piston rod 41 is coupled with the piston casing 1. The vehicle frame connector 52 is arranged at one end of the cylinder barrel 51 (e.g., a lower end of the cylinder barrel 51 as shown in FIG. 14), and the cylinder barrel 51 is coupled with the vehicle frame connector 52 through a connecting rod 58. The cylinder barrel 51 is filled with magnetorheological fluid, and the piston assembly is slidably fitted in the cylinder barrel 51. One end of the piston rod 41 extends out of another end of the cylinder barrel 51 (e.g., an upper end of the cylinder barrel 51 as shown in FIG. 13) and is coupled to the suspension connector 53.

The technical advantages of the magnetorheological damper according to example embodiments of the disclosed technology are the same as those of the piston assembly according to the above embodiments.

As shown in FIG. 13 and FIG. 14, the piston assembly divides a chamber of the cylinder barrel 51 into a recovery chamber 511 and a compression chamber 512. The recovery chamber 511 is arranged at the upper end of the piston casing 1, and the compression chamber 512 is arranged at the lower end of the piston casing 1. Both the recovery chamber 511 and the compression chamber 512 are filed with magnetorheological fluid. When the piston rod 41 moves up and down, the magnetorheological fluid can circulate between the recovery chamber 511 and the compression chamber 512.

Specifically, as shown in FIG. 13, the recovery chamber 511 of the cylinder barrel 51 is equipped with a guide sleeve 55 and an oil seal structure 56. The piston rod 41 is threaded through the guide sleeve 55, which is used to provide guidance for the movement of the piston rod 41. The oil seal structure 56 is located at the upper end of the cylinder barrel 51 to prevent fluid leakage.

As shown in FIG. 14, there is also a gas piston 54 inside the cylinder barrel 51. The gas piston 54 is slidably mounted at the lower end of the piston casing 1 and defines a gas chamber 513 with the cylinder barrel 51. The gas chamber 513 is filled with nitrogen gas. As shown in FIG. 14, the lower end of the cylinder barrel 51 is provided with a valve core assembly 57 for inflating the gas chamber 513. The chambers inside the cylinder barrel 51 are, from top to bottom, the recovery chamber 511, the compression chamber 512, and the gas chamber 513.

Some embodiments, in accordance with the disclosed technology, include a vehicle that includes a magnetorheological damper in example embodiments of the disclosed technology. It can be understood that the suspension connector 53 of the magnetorheological damper is hinged to a vehicle axle 61 of the vehicle, and the vehicle frame connection 52 of the magnetorheological damper is elastically connected to a vehicle frame 62 of the vehicle.

Example technical advantages of the vehicle in example embodiments of the disclosed technology include at least the same as those of the piston assembly and the magnetorheological damper discussed for the above embodiments.

### CONCLUSION

In this disclosure, it should be understood that orientations or position relationships indicated by terms “central,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” “circumferential,” etc. are based on the orientations or position relationships illustrated in the accompanying drawings, and are only for convenience of describing the disclosed technology and simplifying the description, rather than indicating or implying that devices or components referred to must have a particular orientation, be constructed and operated in the particular orientation.

Additionally, the terms “first” and “second” are used for descriptive purposes only and shall not be construed as indicating or implying relative importance or implicitly specifying the quantity of the indicated technical features. Thus, a feature defined with “first” or “second” may explicitly or implicitly include at least one such feature. In this disclosure, the term “a plurality of” means at least two, such as two, three, etc., unless explicitly and specifically defined otherwise.

In the disclosure, unless otherwise specified and limited, terms “mount,” “couple,” “connect,” “fix,” and other terms should be broadly understood. For example, they may be a fixed connection, a detachable connection, or integrated. They may also be a mechanical connection, an electrical connection, or communication with each other. They may be directly coupled or indirectly coupled through an intermediate medium. They may be an internal connection of two components or an interaction relationship between two components, unless otherwise specified. For ordinary those skilled in the art, specific meanings of the above terms in the disclosure may be understood based on specific cases.

In the disclosure, unless otherwise specified and limited, the first feature is “above” or “below” the second feature, which means that the first feature may be in direct contact with the second features, or the first feature may be in indirect contact with the second features through an intermediate media. Moreover, if the first feature is “on,” “above” and “on top of” the second feature, which means that the first feature is directly or diagonally above the second feature or simply indicates that the first feature is horizontally higher than the second feature. The first feature is “under,” “below,” and “on bottom of” the second feature, which means that the first feature is directly or diagonally below the second feature, or simply indicates that the horizontal height of the first feature is less than that of the second feature.

In the disclosure, terms “an embodiment,” “some embodiments,” “an example,” “a specific examples,” or “some examples” means that a specific feature, structure, material, or characteristic described in connection with embodiments or examples is included in at least one embodiment or example of the disclosed technology. In this specification, the illustrative expressions of the above terms do not necessarily refer to the same embodiments or examples. Moreover, the specific feature, structure, material, or characteristic described may be combined in any suitable manner in one or more embodiments or examples. In addition, those skilled in the art may connect and combine different embodiments or examples as well as features of different embodiments or examples described in this specification, without conflicting with each other.

Although embodiments of the disclosed technology have been shown and described above, it can be understood that the above embodiments are illustrative and cannot be understood as a limitation of the disclosed technology. Those ordinary skilled in the art can make changes, modifications, alternatives, and variations to the above embodiments within the scope of the disclosed technology.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A piston assembly, comprising:
a piston casing having a first end and a second end along an axial direction of the piston casing, wherein a mounting chamber is arranged inside the piston casing, the first end of the piston casing is provided with a fluid inlet, and the second end of the piston casing is provided with a fluid outlet;
a coil component arranged coaxially in the mounting chamber; and
an iron core component, comprising:
a primary iron core arranged inside the mounting chamber and sleeved inside the coil component, wherein a central main flow channel is arranged inside the primary iron core axially runs through the primary iron core; and
a secondary iron core arranged inside the mounting chamber and arranged at an end of the primary iron core along an axial direction of the mounting chamber, wherein a central auxiliary flow channel is arranged inside the secondary iron core and axially runs through the secondary iron core, and an outer peripheral wall of the secondary iron core and an inner peripheral wall of the piston casing define an edge axial flow channel, and wherein the secondary iron core has a first end and a second end, the first end of the secondary iron core and the piston casing define an auxiliary radial flow channel, and the second end of the secondary iron core and the primary iron core define a main radial flow channel;
wherein the edge axial flow channel and the central auxiliary flow channel are both in communication with the auxiliary radial flow channel and the main radial flow channel, the main radial flow channel is in communication with the central main flow channel, and the edge axial flow channel is in communication with the fluid inlet and the fluid outlet.

2. The piston assembly of claim 1, wherein an axial gap of the auxiliary radial flow channel is smaller than an axial gap of the main radial flow channel.

3. The piston assembly of claim 2, wherein the axial gap of the auxiliary radial flow channel is L1, and the axial gap of the main radial flow channel is L2, where 0.8 mm≤L1≤1.2 mm, and 2.8 mm≤L2≤3.2 mm.

4. The piston assembly of claim 1, wherein the primary iron core has a first side and a second side, and there are two secondary iron cores, which are:
a first secondary iron core arranged at the first side of the primary iron core, wherein the first secondary iron core defines a first edge axial flow channel, a first auxiliary radial flow channel, and a first main radial flow channel with the piston casing and the primary iron core; and
a second secondary iron core arranged at the second side of the primary iron core, wherein second secondary iron core defines a second edge axial flow channel, a second auxiliary radial flow channel, and a second main radial flow channel with the piston casing and the primary iron core.

5. The piston assembly of claim 4, wherein the piston casing comprises:
a sleeve iron core having a first end and a second end;
a piston upper cover arranged at the first end of the sleeve iron core and provided with the fluid inlet; and
a piston lower cover arranged at the second end of the sleeve iron core and provided with the fluid outlet;
wherein the piston upper cover and the piston lower cover define the mounting chamber with the sleeve iron core; and
wherein the first secondary iron core, the piston upper cover and the sleeve iron core define a set of the first edge axial flow channel, the first auxiliary radial flow channel and the first main radial flow channel which are in communication with the fluid inlet, and the second secondary iron core, the piston lower cover and the sleeve iron core define a set of the second edge axial flow channel, the second auxiliary radial flow channel and the second main radial flow channel which are in communication with the fluid outlet.

6. The piston assembly of claim 1, wherein the coil component comprises:
a coil frame, wherein the primary iron core is arranged inside the coil frame, and a first slot is arranged on one side of the coil frame close to the secondary iron core;
an electromagnetic coil wound on the coil frame; and
a main bracket comprising a main bracket body and a first support arm, wherein the main bracket body is sleeved inside the primary iron core, and the first support arm is arranged on one side of the main bracket body along the axial direction of the mounting chamber, mounted in the first slot and in contact with the secondary iron core.

7. The piston assembly of claim 6, wherein the secondary iron core comprises:
an end iron core, wherein an outer peripheral wall of the end iron core and an inner peripheral wall of the piston casing define the edge axial flow channel;
an auxiliary iron core, wherein the central auxiliary flow channel is arranged inside the auxiliary iron core and axially runs through the auxiliary iron core;
an auxiliary bracket comprising:
an auxiliary bracket body sleeved inside the end iron core, wherein the auxiliary iron core is sleeved inside the auxiliary bracket body; and
a second support arm arranged on one side of the auxiliary bracket body close to the coil frame, wherein a second slot is arranged on one side of the coil frame close to the secondary iron core, and the second support arm is mounted in the second slot.

8. The piston assembly of claim 7, wherein there are at least one of a plurality of first support arms or a plurality of second support arms, and at least one of the plurality of first support arms or the plurality of second support arms are arranged at intervals along a circumference of the auxiliary bracket body to divide the main radial flow channel into a plurality of main radial sub-flow channels.

9. The piston assembly of claim 1, further comprising:
a piston rod coupled with the piston casing and provided with a wire channel that axially runs through the piston rod, wherein the wire channel is in communication with the mounting chamber; and
a wire threaded through the wire channel and electrically connected to the coil component.

10. The piston assembly of claim 9, further comprising a sealing filler, wherein the sealing filler is arranged inside the wire channel and wraps around the wire.

11. The piston assembly of claim 9, wherein the piston assembly further comprising a wear-resistant strip, wherein the wear-resistant strip is sleeved on an outer peripheral wall of the piston casing.

12. A magnetorheological damper, comprising:
a cylinder barrel filled with magnetorheological fluid, wherein the cylinder barrel having a first end and a second end;
a vehicle frame connector arranged at the first end of the cylinder barrel;
a suspension connector; and
a piston assembly slidably fitted in the cylinder barrel, comprising:
a piston casing having a first end and a second end along an axial direction of the piston casing, wherein a mounting chamber is arranged inside the piston casing, the first end of the piston casing is provided with a fluid inlet, and the second end of the piston casing is provided with a fluid outlet;
a coil component arranged coaxially in the mounting chamber;
a piston rod coupled with the piston casing and having a first end and a second end, wherein the first end of the piston rod extends out of the second end of the cylinder barrel and is coupled with the suspension connector; and
an iron core component, comprising:
a primary iron core arranged inside the mounting chamber and sleeved inside the coil component, wherein a central main flow channel is arranged inside the primary iron core axially runs through the primary iron core; and
a secondary iron core arranged inside the mounting chamber and arranged at an end of the primary iron core along an axial direction of the mounting chamber, wherein a central auxiliary flow channel is arranged inside the secondary iron core and axially runs through the secondary iron core, and an outer peripheral wall of the secondary iron core and an inner peripheral wall of the piston casing define an edge axial flow channel, and wherein the secondary iron core has a first end and a second end, the first end of the secondary iron core and the piston casing define an auxiliary radial flow channel, and the second end of the secondary iron core and the primary iron core define a main radial flow channel;
wherein the edge axial flow channel and the central auxiliary flow channel are both in communication with the auxiliary radial flow channel and the main radial flow channel, the main radial flow channel is in communication with the central main flow channel, and the edge axial flow channel is in communication with the fluid inlet and the fluid outlet.

13. The magnetorheological damper of claim 12, wherein an axial gap of the auxiliary radial flow channel is smaller than an axial gap of the main radial flow channel.

14. The magnetorheological damper of claim 13, wherein the axial gap of the auxiliary radial flow channel is L1, and the axial gap of the main radial flow channel is L2, where 0.8 mm≤L1≤1.2 mm, and 2.8 mm≤L2≤3.2 mm.

15. The magnetorheological damper of claim 12, wherein the primary iron core has a first side and a second side, and there are two secondary iron cores, which are:
a first secondary iron core arranged at the first side of the primary iron core, wherein the first secondary iron core defines a first edge axial flow channel, a first auxiliary radial flow channel, and a first main radial flow channel with the piston casing and the primary iron core; and
a second secondary iron core arranged at the second side of the primary iron core, wherein the second secondary iron core defines a second edge axial flow channel, a second auxiliary radial flow channel, and a second main radial flow channel with the piston casing and the primary iron core.

16. The magnetorheological damper of claim 15, wherein the piston casing comprises:
a sleeve iron core having a first end and a second end;
a piston upper cover arranged at the first end of the sleeve iron core and provided with the fluid inlet; and
a piston lower cover arranged at the second end of the sleeve iron core and provided with the fluid outlet;
wherein the piston upper cover and the piston lower cover define the mounting chamber with the sleeve iron core; and
wherein the first secondary iron core, the piston upper cover and the sleeve iron core define a set of the first edge axial flow channel, the first auxiliary radial flow channel and the first main radial flow channel which are in communication with the fluid inlet, and the second secondary iron core, the piston lower cover and the sleeve iron core define a set of the second edge axial flow channel, the second auxiliary radial flow channel and the second main radial flow channel which are in communication with the fluid outlet.

17. The magnetorheological damper of claim 12, wherein the coil component comprises:
a coil frame, wherein the primary iron core is arranged inside the coil frame, and a first slot is arranged on one side of the coil frame close to the secondary iron core;
an electromagnetic coil wound on the coil frame; and
a main bracket comprising a main bracket body and a first support arm, wherein the main bracket body is sleeved inside the primary iron core, and the first support arm is arranged on one side of the main bracket body along the axial direction of the mounting chamber, mounted in the first slot and in contact with the secondary iron core.

18. The magnetorheological damper of claim 17, wherein the secondary iron core comprises:
an end iron core, wherein an outer peripheral wall of the end iron core and an inner peripheral wall of the piston casing define the edge axial flow channel;
an auxiliary iron core, wherein the central auxiliary flow channel is arranged inside the auxiliary iron core and axially runs through the auxiliary iron core; and
an auxiliary bracket comprising:
an auxiliary bracket body sleeved inside the end iron core, wherein the auxiliary iron core is sleeved inside the auxiliary bracket body; and
a second support arm arranged on one side of the auxiliary bracket body close to the coil frame, wherein a second slot is arranged on one side of the coil frame close to the secondary iron core, and the second support arm is mounted in the second slot.

19. The magnetorheological damper of claim 18, wherein there are at least one of a plurality of first support arms or a plurality of second support arms, and at least one of the plurality of first support arms or the plurality of second support arms are arranged at intervals along a circumference of the auxiliary bracket body to divide the main radial flow channel into a plurality of main radial sub-flow channels.

20. A vehicle comprising a magnetorheological damper, wherein the magnetorheological damper comprises:
a cylinder barrel filled with magnetorheological fluid, wherein the cylinder barrel having a first end and a second end;
a vehicle frame connector arranged at the first end of the cylinder barrel;
a suspension connector; and
a piston assembly slidably fitted in the cylinder barrel, comprising:
a piston casing having a first end and a second end along an axial direction of the piston casing, wherein a mounting chamber is arranged inside the piston casing, the first end of the piston casing is provided with a fluid inlet, and the second end of the piston casing is provided with a fluid outlet;
a coil component arranged coaxially in the mounting chamber;
a piston rod coupled with the piston casing and having a first end and a second end, wherein the first end of the piston rod extends out of the second end of the cylinder barrel and is coupled with the suspension connector; and
an iron core component, comprising:
a primary iron core arranged inside the mounting chamber and sleeved inside the coil component, wherein a central main flow channel is arranged inside the primary iron core axially runs through the primary iron core; and
a secondary iron core arranged inside the mounting chamber and arranged at an end of the primary iron core along an axial direction of the mounting chamber, wherein a central auxiliary flow channel is arranged inside the secondary iron core and axially runs through the secondary iron core, and an outer peripheral wall of the secondary iron core and an inner peripheral wall of the piston casing define an edge axial flow channel, and wherein the secondary iron core has a first end and a second end, the first end of the secondary iron core and the piston casing define an auxiliary radial flow channel, and the second end of the secondary iron core and the primary iron core define a main radial flow channel;
wherein the edge axial flow channel and the central auxiliary flow channel are both in communication with the auxiliary radial flow channel and the main radial flow channel, the main radial flow channel is in communication with the central main flow channel, and the edge axial flow channel is in communication with the fluid inlet and the fluid outlet.
